(19) United States
(12) Patent Application Publication
(10) Pub. No.: US 2005/0065844 A1
(43) Pub. Date: Mar. 24, 2005

(54) System and method for managing an advertising campaign on a network

(75) Inventors: Ravi Raj, Los Altos, CA (US); Bhavesh Mehta, Cupertino, CA (US)

Correspondence Address: DARBY & DARBY P.C., P. O. BOX 5257, NEW YORK, NY, 10150-5257, US

(73) Assignee: Yahoo! Inc.

(21) Appl. No.: 10/671,268

(22) Filed: Sep. 24, 2003

(51) Int. Cl. G06F 17/60

(52) U.S. Cl. 705/14; 705/26

(57) ABSTRACT

The invention is directed to a system and method for automating the management of an advertising campaign for a sponsored search application. An advertiser can easily manage their advertising campaign based on a budget and other information that they are most familiar with, e.g., the length of time for the campaign, desired number of total clicks during the campaign, the time zone of the campaign, keywords to be bid upon for the sponsored search application, the advertisement (copy and heading), and the URL associated with the location of the advertisement copy. With this relatively basic information provided, the invention can automatically manage the bidding on both small and relatively large numbers of keywords for an advertising campaign.

### FIELD OF THE INVENTION

The present invention is generally directed to advertising, and more particularly, to enabling the management of an advertising campaign on a network.

### BACKGROUND OF THE INVENTION

Click through advertising is an important source of revenue for many companies that provide products and services to consumers over the Internet. Also, pay-per-click (PPC) advertising has gained favor with many advertisers because they only pay on the basis of performance, i.e., the cost per click (CPC) that actually results in a user browsing an advertiser's web site. Typically, an advertiser bids for ranking in the results for a keyword provided to a sponsored search application. For example, an advertiser with the highest bid for a particular keyword would get the top most position in a ranked list and the next highest bidder would be assigned the second highest position in the list.

Additionally, advertisers often prefer CPC based mechanisms because they give advertisers the flexibility to set their own price for how much they are willing to pay for each click that originates from a particular keyword. Since advertisers bid against each other for a position on the ranked list generated by a sponsored search application, the actual price each advertiser is willing to pay determines the cost per click not the service provider that supports the sponsored search application.

Unfortunately, managing a PPC advertising campaign with several hundred keywords and separate bids for each keyword has been cumbersome and time-consuming. Also, since each keyword and corresponding bid had to be manually provided, it has been difficult to effectively manage a budget for a PPC advertising campaign over a significant period of time, such as a month.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows a schematic diagram of an illustrative operating environment for the present invention;

FIG. 2 illustrates a flow diagram of an overview of a process for automatically managing the results of an advertising campaign based on keywords in a sponsored search application;

FIG. 3 shows a flow diagram for providing information to be employed to optimize bids on keywords in a sponsored search application;

FIG. 4 illustrates an exemplary graphical interface for providing information to optimize bids on keywords for a sponsored search application;

FIG. 5 shows an exemplary flow diagram for optimally bidding on keywords associated with the advertising campaign with a selected cost per acquisition method;

FIG. 6 illustrates pseudo code for automatically placing optimal bids on keywords in a sponsored search application;

FIG. 7 shows a table of values that are employed by the pseudo code shown in FIG. 6 for the optimal placement of bids on keywords in a sponsored search application;

FIG. 8 illustrates an exemplary flow diagram for automatically determining which version of content generates more clicks;

FIG. 9 illustrates an exemplary report for each keyword associated with the advertising campaign; and

FIG. 10 shows an exemplary calendar interface for displaying cost information on a daily basis for an advertising campaign, in accordance with the present invention.

### DETAILED DESCRIPTION OF THE PREFERRED EMBODIMENT

The present invention now will be described more fully hereinafter “with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification, the term “connected” means a direct connection between the things that are connected, without any intermediary devices or components. The term “coupled,” means a direct connection between the things that are connected, or an indirect connection through one or more either passive or active intermediary devices or components. The meaning of “a,” “an,” and “the” include plural references. The meaning of “in” includes “in” and “on.”

Briefly stated, the invention is direct to a system and method for automating the management of an advertising campaign for results in a sponsored search application. An advertiser can easily manage the number of acquisitions (clicks) that are received over time with an advertising campaign based on a budget and other information that they are most familiar with, e.g., the length of time for the campaign, desired number of total clicks during the campaign, the time zone of the campaign, keywords to be bid upon for the sponsored search application, the advertisement (copy and heading), and the URL associated with the location of the advertisement copy. With this relatively basic information provided, the invention can automatically manage the bidding on both small and relatively large numbers of keywords for an advertising campaign that is implemented with a sponsored search application.

At least one predetermined or customized method can be selected for delivering bids on keywords. In one method, the maximum number of acquisitions, such as clicks, are provided for the minimum cost over a provided period of time. In another method, a maximum number of acquisitions are provided in the shortest period of time. In yet another method, a budget is divided into several sub-budgets for corresponding time intervals. In these time intervals, the maximum number of acquisitions are made based upon the funds available in the sub-budget.

In one embodiment, an advertiser can provide multiple versions of advertising copy that can be alternatively employed with a sponsored search application. After a period of time, a determination is made as to which version(s) of the advertising copy is generating the most clicks for the sponsored search application. Once the particular version(s) of the advertising copy with the most clicks is identified, only this version(s) is subsequently primarily employed with the sponsored search application.

In yet another embodiment, a profile can be generated for each client that automatically provides substantially the same budget, desired number of clicks, and keywords used in a previous advertising campaign for the client. A profile can also be provided for a new client that includes a suggested budget and/or desired number of clicks over a period of time, e.g., day, week, month, quarter, year, and the like. Moreover, profiles can be generated for a repeat client that provides a budget and/or desired number of clicks that are substantially greater than those employed with a previous advertising campaign.

Illustrative Operating Environment

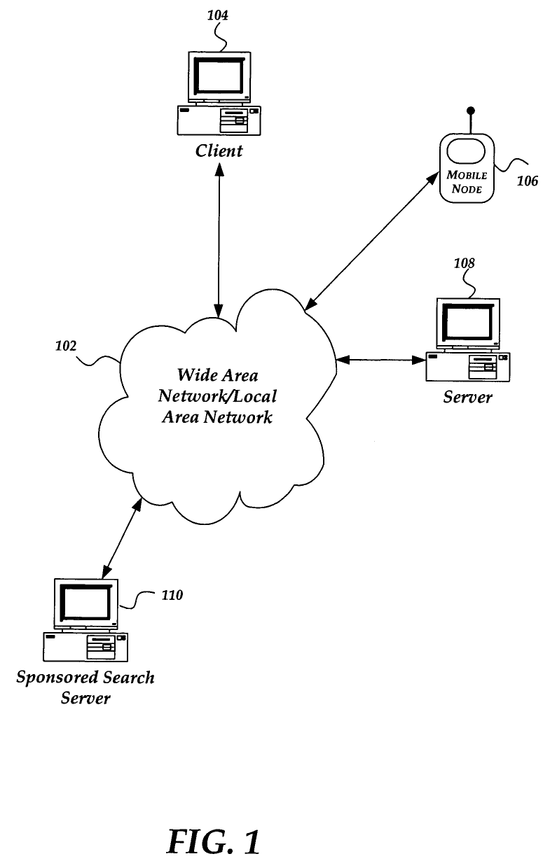

FIG. 1 shows components of an exemplary environment in which the invention may be practiced. Not all the components may be required to practice the invention, and variations in the arrangement and type of the components may be made without departing from the spirit or scope of the invention.

In FIG. 1, one or more local area networks (“LANs”) and/or wide area networks (“WAN”) are included in a network 102, such as the Internet, that enables communication between various users, devices, servers, clients, processes, and the like. As shown, client 104, mobile node 106, sponsored search server 110 and server 108, are shown employing network 102 to communicate with each other, and the like. Mobile node 106 can couple to network 102 using a wireless communications medium. The mobile node can include a mobile telephone, smart phone, pager, walkie talkie, radio frequency (RF) device, infrared (IR) device, WI-FI device, and integrated devices combining one or more of the preceding devices, and the like.

Although not shown, the LANs and WANs of network 102 are typically interconnected by routers and/or switches. Also, communication links within the LANs and WANS can include twisted pair, fiber optics, or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links, and the like. Furthermore, the number of WANs, and LANs in FIG. 1 may be increased or decreased arbitrarily without departing from the spirit or scope of this invention.

The media used to transmit information in communication links as described above illustrates one type of computer-readable media, namely communication media. Generally, computer-readable media includes any media that can be accessed by a computing device. Computer-readable media may include computer storage media, communication media, or any combination thereof.

Additionally, communication media typically embodies computer-readable instructions, data structures, program modules, or other data in a modulated data signal such as a carrier wave or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

Sponsored search server 110 includes, among other components, a central processing unit (processor), a memory for storing instructions, and a network interface unit connected via a bus. The network interface unit includes the necessary circuitry for connecting sponsored search server 110 to network 102, and is constructed for use with various communication protocols including the TCP/IP and UDP/IP protocols. The network interface unit may include or interface with circuitry and components for communicating information, such as graphical displays, advertiser data, and the like over a wired and/or wireless communications medium. Network interface unit is sometimes referred to as a transceiver.

Advertising Campaign Methods

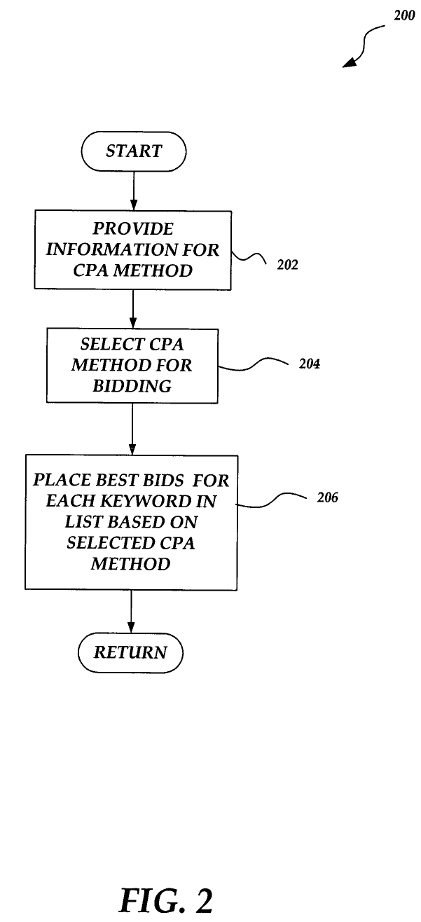

FIG. 2 shows flow chart 200 of an overview of exemplary actions for automatically managing an advertising campaign based on a cost per acquisition method for a sponsored search application. Moving from a start block to block 202, various types of information are provided for use with a cost per acquisition (CPA) method, including, but not limited to, budget, number of acquisitions such as clicks, time intervals, positions, average cost per acquisition, keywords, content such as advertising copy and headlines, and Uniform Resource Locator (URL). Next, the process moves to block 204 where at least one CPA is selected for bidding on acquisitions, including, minimum cost for the most acquisitions, shortest time for the most acquisitions, time interval budget for acquisitions, custom, and the like.

The process moves next to block 206 where best bids are placed for each keyword based on the CPA selected for bidding in block 204. Upon completion of block 206, the process returns to performing other actions.

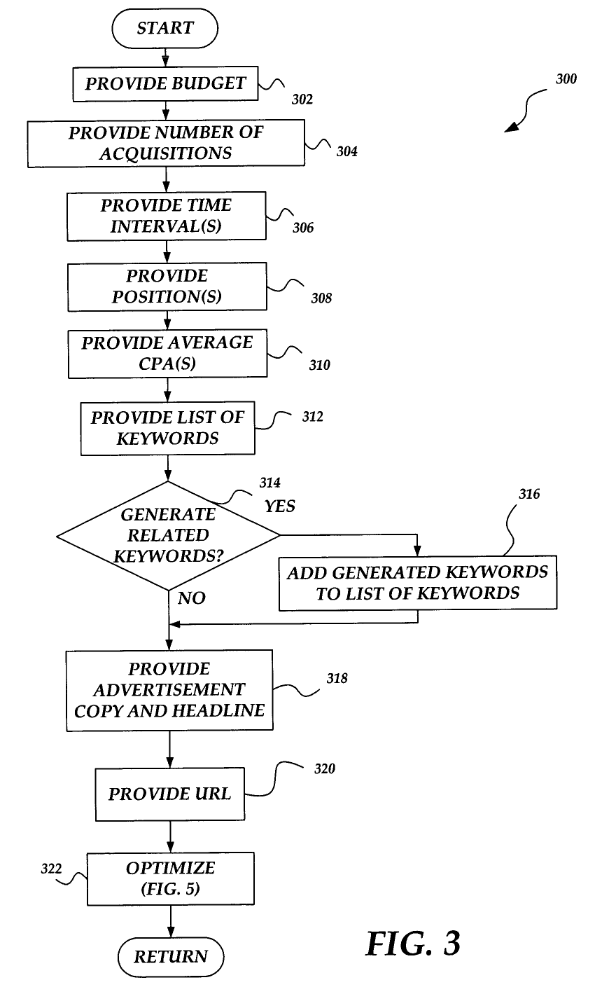

FIG. 3 illustrates a flow chart of an overview of exemplary actions to provide information that is employed by a selected CPA method to place optimal bids on keywords in a sponsored search application. Moving from a start block, the process steps to block 302 where a budget is provided for the acquisitions. The process flows to block 304 where at least a total amount of acquisitions is provided.

At block 306, the time interval for bidding on keywords for acquisitions is provided. The time zone for the advertising campaign can be optionally provided. For example, an advertiser wanting to target an advertising campaign to the west coast of the United States could select a time interval suited to the Pacific time zone. Although not shown, the particular hours during the day that the advertising campaign will be enabled can also be selected. For example, an advertising campaign directed to young families on the west coast of the USA might be enabled from the hours of 8:00 AM to 9:30 PM Pacific Standard time.

Stepping to block 308, the positions for bidding on keywords in the results of a sponsored search application are provided. Typically, just the first three positions are bid upon, however, it is understood that the invention supports bidding on lower positions.

Proceeding to block 310, at least one average cost per acquisition is provided. Next, the process advances to block 312 where a list of keywords is provided for bidding purposes.

At block 312, at least one keyword is provided. Stepping to decision block 314, the process determines if related words are to be generated. If so, the process advances to block 316 were at least one generated keyword is added to a list of at least one provided keyword. Next, the process moves to block 318 where content such as advertisement text, headlines, pictures, graphics, and the like, are provided. Also, if the determination at decision block 314 had been false, the process would have moved directly to block 318.

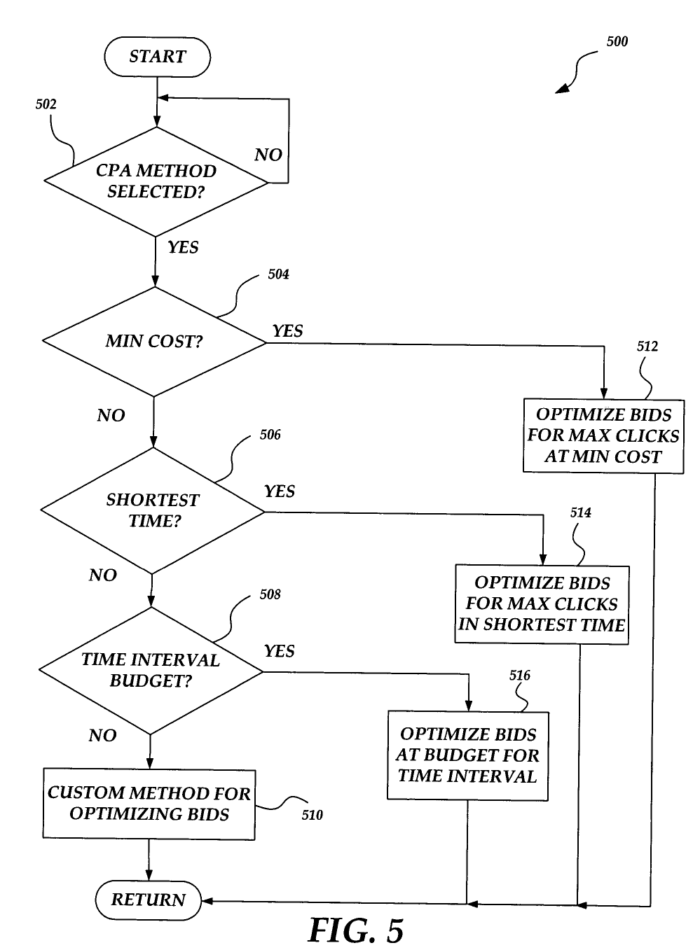

From block 318, the process steps to block 320 where a URL is provided. Next, the process flows to block 322 where the optimal bids for keywords are placed with a selected CPA method. The process in block 322 is described in greater detail in the discussion of FIG. 5. Finally, the process advances to a return block and returns to performing other actions.

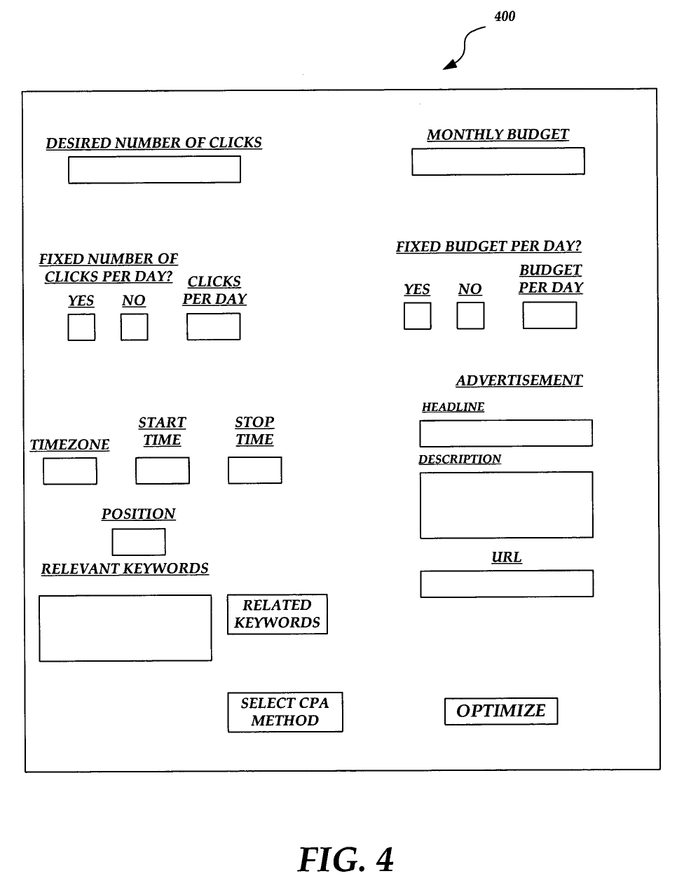

FIG. 4 illustrates an exemplary graphical interface 400 for providing information that is employed by at least one CPA method to optimize the bidding on keyword based results in a sponsored search application. Text entry boxes are provided for monthly budget (can also be shorter or longer intervals), desired number of clicks/acquisitions, time zone, start time, stop time, number of clicks per day, budget per day, position, relevant keywords, advertising headline, advertising copy, and URL. A control is provided for enabling the generation of additional keywords related to the initially provided keywords and another control is provided for optimizing the information provided for the advertising campaign. Another control is provided for selecting a CPA method. Additionally, yet another control is provided for enabling a selected CPA method to optimize the bidding on keyword results in a sponsored search application based on the different types of provided information.

FIG. 5 illustrates flow chart 500 of an overview of the actions performed in the implementation of a selected CPA method. Briefly stated, the process advances to decision block 502 where a determination is made whether a CPA method has been selected. If not, the process loops until such a determination is made. When a CPA method is selected, the process steps to decision block 504 where a determination is made as to whether the selected CPA method enables the maximum number of acquisitions/clicks for the minimum cost has been selected. If true, the process moves to block 512 where the process places bids with the sponsored search application to cause the maximum number of acquisitions to occur for the least expensive cost over the provided time interval, e.g., day, week, or month. Moving from block 512, the process steps to the return block where it returns to performing other actions.

Alternatively, if the determination at decision block 504 was false, the process moves to decision block 506 where a determination is made as to whether the selected CPA method enables the maximum number of acquisitions to be occur in a sponsored search application in the shortest period of time. If true, the process moves to block 514 where this CPA method is performed. Next the process moves to a return bock and returns to performing other actions.

However, if the determination at decision block 506 was false, the process advances to block 508 where a determination is made as to whether the selected CPA method enables a budget for acquisitions such as a monthly budget for causing the maximum number of acquisitions to be divided up into separate budgets, e.g., daily budgets, that are used to place the maximum number of successful bids for keywords with a sponsored search application. If true, the process advances to block 516 where the time interval budget CPA method is performed. Next, the process flows to an end block and returns to performing other actions.

Alternatively, if the determination at decision block 508 is false, the process steps to block 510 where a custom method for optimizing bids for keywords in the results from a sponsored search application is implemented. One type of custom method might incorporate certain aspects of other predetermined CPA methods or enable modifications to these predetermined CPA methods. For example, the invention could enable a time interval CPA method to be customized to maximize the number of successful bids for keywords in the shortest period of time within the time interval. In any event, the process steps from block 510 and returns to performing other actions.

Additionally, there may not be enough successful bids for keywords in a particular time interval, such as a day, to spend the entire budget for a time interval. In this case, the invention can enable the left over budget to be added to the next time interval or spread out over the remaining time intervals. Furthermore, the invention enables a user to dynamically modify any of the provided information and selected CPA method(s) at any time.

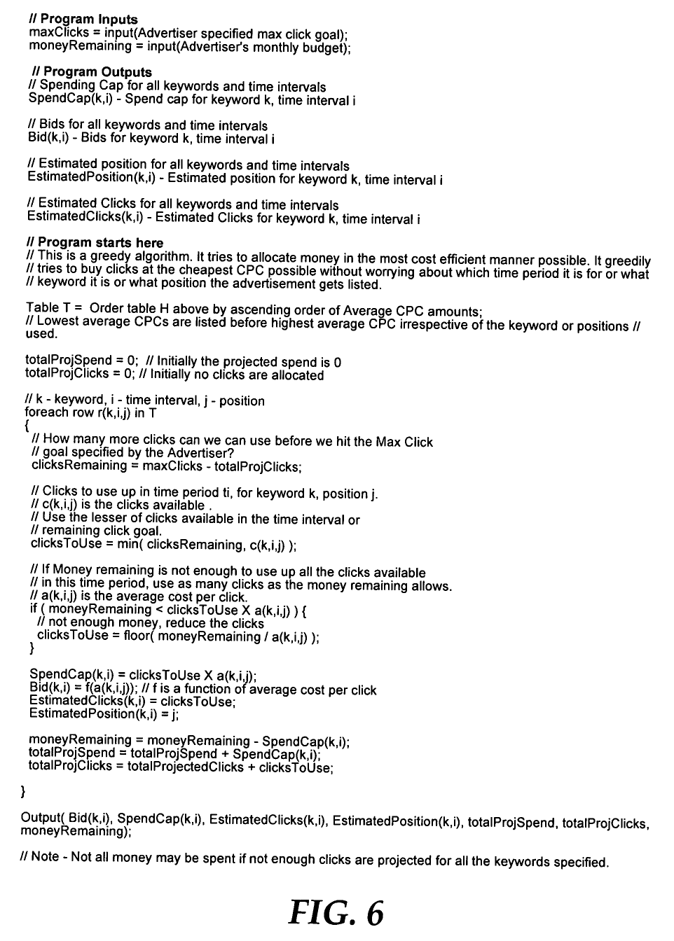

FIG. 6 illustrates pseudo code for a CPA method that maximizes acquisitions at a minimum cost and does not require a particular number of successful bids on keywords in a particular time interval. For this type of CPA method, the acquisitions typically are not smoothly provided over a time interval. With minimal recoding this pseudo code can be modified to implement a CPA method that maximizes the number of acquisitions over the shortest time interval. Also, this pseudo code can be changed slightly to spend a selected sub-budget for successful key word bids over a series of selected time intervals without departing from the spirit and scope of the invention.

To further understand the pseudo code presented in FIG. 6, the explanations for the various variables are as follows:
monthlyBudget—Monthly Budget.
totalProj Spend—Projected Spend per month.
maxClicks—Maximum Clicks Desired per month, cannot be zero. Note, there is not necessarily a guarantee of delivering this max goal.
totalProjClicks—Total projected clicks that will be delivered per month.
kw1, kw2, kw3, . . . , kwk—k Keywords selected by the user.
p1, p2, . . . , pj—j positions available for advertisement listing on a sponsored search web site.
t1, t2, . . . , ti—i equal time intervals across the total time (month) when Advertisement copy is active. Accounts for Start and End times specified by the Advertiser. The actual size of the time interval is determined by empirical study. It could be set to a week, day, hour, minute, etc.
a(i,j,k)—Average Cost per click (CPC) for time period i, position j, keyword k. e.g. a(15,2,32) is the average cost for time period 15, 2nd position, 32nd keyword. The data is inferred from Historical data. Appropriate prediction and seasonal models may be applied to historical data to represent the future as closely as possible.
c(i,j,k)—Clicks available for time period i, position j, keyword k. e.g. c15,2,32 is the clicks available for time period 15, 2nd position, 32nd keyword. The data can be inferred from Historical data. Appropriate prediction and seasonal models may be applied to historical data to represent the future as closely as possible.
Delivery Option—S for smooth delivery of clicks over the month, Q for as quick as possible delivery of clicks, N for non-smooth delivery of clicks across the month getting maximum clicks for the dollars.

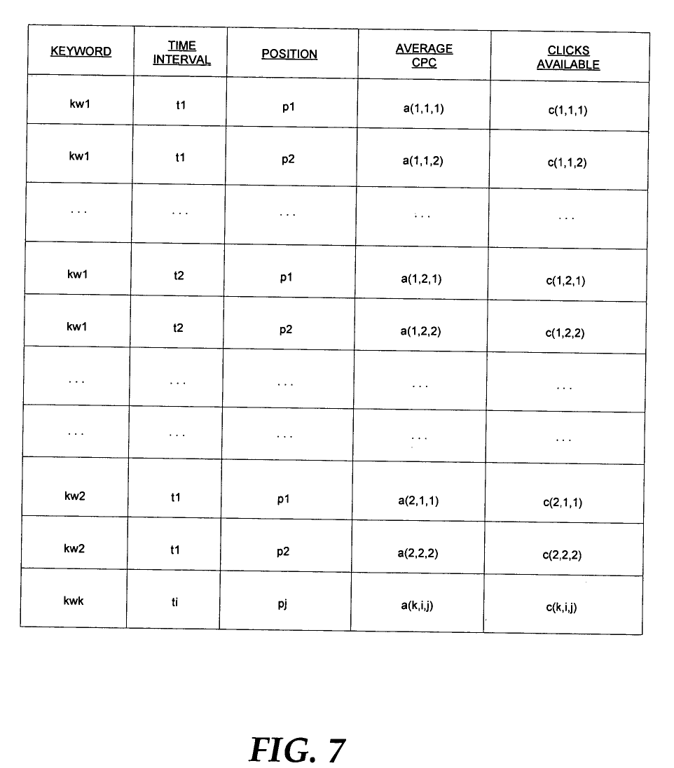

FIG. 7 illustrates a table of provided information that is employed with the pseudo code discussed above for FIG. 6. In the table, some of the exemplary date includes a listing for the average cost per click and clicks available for all keywords, by time interval and position (rank) in the listing.

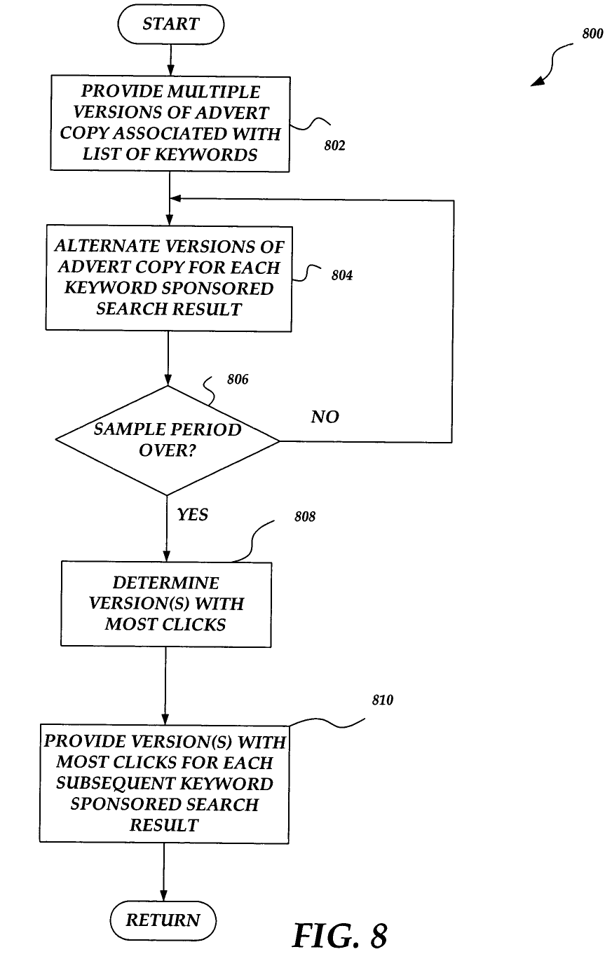

FIG. 8 illustrates an overview 800 of a flow chart for managing alternative versions of advertising copy for the same keyword(s) until at least one of the versions is determined to generate more acquisitions/clicks than the other versions. Moving from a start block, the process advances to block 802 where multiple versions of advertising copy are provided. At block 804, the multiple versions of the advertising copy are alternated in the ranked list for a sponsored search application. At decision block 806, a determination is made as to whether a sampling period has expired. If not, the process loops back to block 804 and performs substantially the same actions as discussed above.

However, if the determination at decision block 804 is affirmative, the process moves to block 808 where a determination is made as to which version(s) of the advertising copy causes the most clicks to occur. The process flows to block 810 where just the version of the advertising copy that generates the most clicks is provided for the keyword search results in a sponsored search application. In another embodiment, the different versions of the advertising copy can be weighted so that each version that causes the most clicks are provided more often for the keyword search than other versions that cause less clicks to be generated. Next, the process returns to performing other actions.

Additionally, although not shown, in another embodiment, the budget and cost per click (CPC) for at least one particular keyword can be manually selected. Furthermore, the manual optimization process discussed above may be performed once or repeatedly over the course of the advertising campaign, e.g., hourly, daily, weekly, and the like.

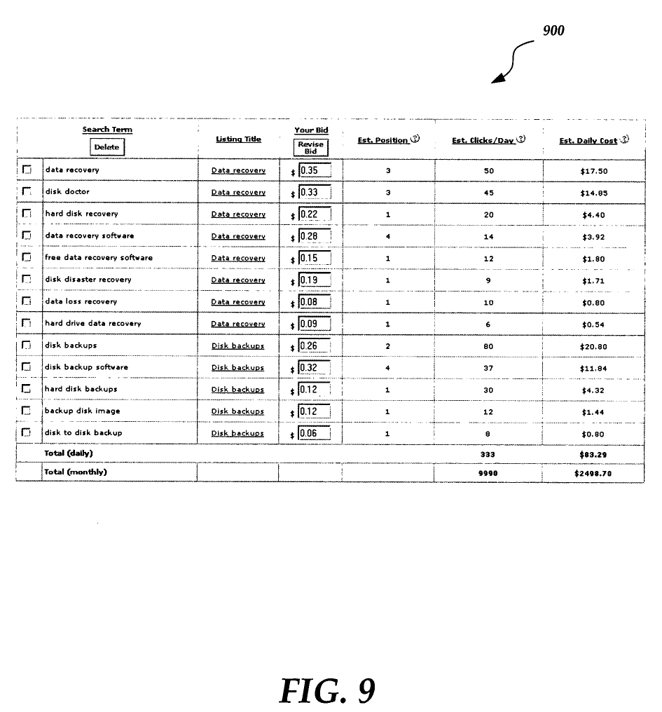

FIG. 9 illustrates an exemplary budget report 900 with the projected best bid results for several previously provided keywords. Although not intended to be exhaustive, this exemplary report has columns for keyword (search term), category (listing title), bids, estimated position of bid, estimated clicks per day, and estimated cost for clicks per day.

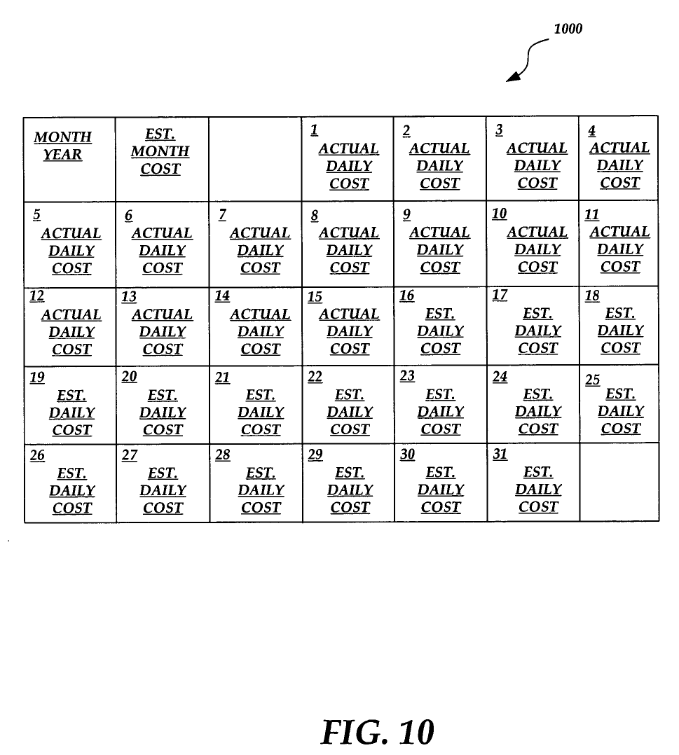

FIG. 10 illustrates an exemplary calendar graphical user interface 1000 for the estimated monthly cost of an advertising campaign. As indicated the actual or estimated daily cost for an advertising campaign can be shown over the course of a period of time.

The above specification, examples and data provide a complete description of the manufacture and use of the composition of the invention. Since many embodiments of the invention can be made without departing from the spirit and scope of the invention, the invention resides in the claims hereinafter appended.

1. A method for placing predetermined content in a result from a sponsored search, comprising:
enabling at least a budget to be provided for placing a bid on a keyword, wherein the bid is associated with predetermined content that corresponds to the keyword;
enabling a selection of at least one method for placing at least one bid for the keyword in the result from the sponsored search;
enabling an automatic placement of at least one bid for the keyword based on the selected method; and
enabling a display of predetermined content that is associated with at least one bid for the keyword and whose value is employed to acquire placement of the predetermined content in the result from the sponsored search.

2. The method of claim 1, wherein acquiring of the placement of the predetermined content further comprises ranking of the predetermined content based in part on the value of each bid.

3. The method of claim 1, wherein placing at least one bid further comprises at least one of placing a bid to acquire the placement of predetermined content in at least one of a lower position in the result of the sponsored search, and placing a bid to acquire the placement of predetermined content in at least one of a first three positions in the result of the sponsored search.

4. The method of claim 1, wherein the selected method includes at least one of minimum cost for maximum acquisitions, shortest time for maximum acquisitions, time interval budget, and custom.

5. The method of claim 4, wherein the custom method further comprises a shortest time for maximum acquisitions within a time interval budget.

6. The method of claim 1, wherein the selected method is configured to enable an unused portion of the budget for a time interval to be included in another time interval.

7. The method of claim 1, wherein the keyword further comprises at least one of a provided keyword, and a generated keyword that is related to the provided keyword.

8. The method of claim 1, further comprising providing information that is employed by the selected method to place at least one bid, wherein the provided information further includes at least one of a total number of acquisitions for a time interval, time interval, position in ranked list of sponsored search result, fixed number of acquisitions for a time interval, start time, stop time, clicks per time interval, sub-budget for a time interval, and relevant keywords.

9. The method of claim 8, wherein the time interval further comprises a time zone for placing at least one bid on the keyword for acquiring placement of the predetermined content in the result of the sponsored search.

10. The method of claim 1, further comprising providing a profile that is employed to provide at least one of the keyword, the budget, and selection of the method for bidding on the keyword.

11. The method of claim 1, further comprising determining multiple versions of predetermined content that corresponds to the keyword;
alternating between each version of predetermined content placed in the result for the sponsored search;
determining a number of clicks associated with each of the multiple versions of predetermined content; and
selecting a version of predetermined content that is associated with a maximum number of clicks, wherein the selected version of predetermined content is employed for a subsequent result in the sponsored search.

12. The method of claim 1 1, wherein each version of predetermined content further comprises a weighting factor that is configured to enable a version of predetermined content with a most number of clicks to be employed in the subsequent result in the sponsored search.

13. A method for managing an advertising campaign for a sponsored search, comprising:
providing at least one keyword, advertising text, and a total number of clicks to be bid on for each keyword over a period of time, wherein each bid for each keyword is employed by the sponsored search to rank placement of advertising text at a position on a displayed list that is generated by the sponsored search in response to a request for at least one provided keyword;
providing a budget for automatically generating at least one bid for each provided keyword over the period of time, wherein each bid is dependent on at least the provided budget and the total number of clicks to be bid on for the at least one provided keyword;
selecting a method for placing each bid for each provided keyword over the period of time; and
in response to a request for at least one provided keyword, employing the selected method to automatically generate a bid for placement of the provided advertising text on the displayed list.

14. The method of claim 13, wherein the placement of the provided advertising text on the displayed list further comprises acquiring placement of the advertising text in at least one of a first three positions on the displayed list, and acquiring placement of the advertising text in a lower position on the ranked list.

15. The method of claim 13, wherein automatically generating at least one bid for each provided keyword further comprises selecting a method for placing each bid based in part on at least one of a minimum cost for maximum acquisitions, shortest time for maximum acquisitions, time interval budget, and custom.

16. The method of claim 13, wherein at least one provided keyword further comprises at least one generated keyword that is related to the at least one provided keyword.

17. A server for placing advertiser data in a result from a sponsored search, comprising:
a memory for storing logical instructions;
a transceiver for communicating over a network, including receiving advertiser data; and
a processor for executing the logical instructions stored in the memory, the execution of the logical instructions causing actions to be performed, including:
receiving at least a budget to be provided for placing a bid on a keyword, wherein the bid is associated with advertiser data that corresponds to the keyword;
receiving a selection of at least one method for placing at least one bid for the keyword in the result from the sponsored search;
determining an automatic placement of at least one bid for the keyword based on the selected method; and
enabling a display of advertiser data that is associated with at least one bid for the keyword and whose value is employed to acquire placement of the advertiser data in the result from the sponsored search.

18. The server of claim 17, wherein the advertiser data further comprises at least one of a number of acquisitions, time interval, position in a ranked list of sponsored search result, advertising copy, headlines, and a Uniform Resource Locator (URL).

19. The server of claim 17, wherein the advertiser data further comprises multiple versions of advertising copy associated with the keyword.

20. The server of claim 17, wherein the selected method includes at least one of minimum cost for maximum acquisitions, shortest time for maximum acquisitions, time interval budget, and custom.

21. The server of claim 17, further comprising an interface application configured to receive the advertiser data.

22. The server of claim 21, wherein the interface application further comprises a graphical interface displayable at a client, the graphical interface further comprises:
an entry box configured to receive at least one of the budget, desired number of clicks, time zone, start time, stop time, number of clicks per day, position, relevant keywords, advertising headline, advertising copy, and a URL; and
a control means for enabling at least one of a generation of additional keywords, an optimization of the received advertiser data, and the determination of the method.

23. A carrier-wave signal including computer-executable instructions for placing predetermined content in a result from a sponsored search, the instructions comprising:
enabling at least a budget to be provided for placing a bid on a keyword, wherein the bid is associated with predetermined content that corresponds to the keyword;
enabling a selection of at least one method for placing at least one bid for the keyword in the result from the sponsored search;
enabling an automatic placement of at least one bid for the keyword based on the selected method; and
enabling a display of predetermined content that is associated with at least one bid for the keyword and whose value is employed to acquire placement of the predetermined content in the result from the sponsored search.

24. The carrier-wave signal of claim 23, wherein acquiring of the placement of the predetermined content further comprises ranking of the predetermined content by the value of each bid.

25. The carrier-wave signal of claim 23, wherein placing at least one bid further comprises at least one of placing a bid to acquire placement of predetermined content in at least one of a lower position in the result of the sponsored search, and placing a bid to acquire the placement of predetermined data in at least one of a first three positions in the result of the sponsored search.

26. The carrier-wave signal of claim 23, wherein the selected method further comprises at least one of minimum cost for maximum acquisitions, shortest time for maximum acquisitions, time interval budget, and custom.

27. The carrier-wave signal of claim 26, wherein the custom method further comprises shortest time for maximum acquisitions within a time interval budget.

28. The carrier-wave signal of claim 23, wherein the keyword further comprises at least one of a provided keyword, and a generated keyword that is relevant to the provided keyword.

29. The carrier-wave signal of claim 23, further comprising providing a profile that is employed to provide at least one of the keyword, the budget, and selection of the method for bidding on the keyword.

30. An apparatus for placing predetermined content in a result from a sponsored search, comprising:
a means for enabling at least a budget to be provided for placing a bid on a keyword, wherein the bid is associated with predetermined content that corresponds to the keyword;
a means for selecting of at least one method for placing at least one bid for the keyword in the result from the sponsored search;
a means for enabling an automatic placement of at least one bid for the keyword based on the selected method; and
a means for enabling a display of predetermined content that is associated with at least one bid for the keyword and whose value is employed to acquire placement of the predetermined content in the result from the sponsored search.
